(19) United States
(12) Patent Application Publication
(10) Pub. No.: US 2010/0236879 A1
(43) Pub. Date: Sep. 23, 2010

(54) METHOD FOR RELEASING A PARKING BRAKE OF A MOTOR VEHICLE

(76) Inventor: Rainer Kober, Darmstadt (DE)

Correspondence Address: King & Spalding LLP, 401 Congress Avenue, Suite 3200, Austin, TX, 78701, US

(21) Appl. No.: 12/376,659

(22) PCT Filed: Aug. 8, 2007
(86) PCT No.: PCT/EP2007/058215

§ 371 Date: Jun. 4, 2010

(30) Foreign Application Priority Data
Aug. 9, 2006 (DE) 10 2006 037 242.5

(51) Int. Cl. F16D 65/28; B60T 17/18; B60T 17/00; F16D 65/30

(52) U.S. Cl. 188/106 R

(57) ABSTRACT

In the method a drive tool (1) is inserted through an opening (3), closed by a membrane (2), of the housing (4) of the control drive (5) of the parking brake into the housing (4) and is placed in a receiving part (6). The receiving part (6) is connected to the transmission (7) in a rotatable manner. Subsequently, the transmission (7) is set in a rotary motion with the drive tool (1) via the receiving part (6) to release the parking brake.

### CROSS-REFERENCE TO RELATED APPLICATIONS

This application is a U.S. National Stage Application of International Application No. PCT/EP2007/058215 filed Aug. 8, 2007, which designates the United States of America, and claims priority to German Patent Application No. 10 2006 037 242.5 filed Aug. 9, 2006. The contents of these applications are incorporated herein in their entirety by this reference.

### TECHNICAL FIELD

The invention relates to a method for releasing a parking brake of a motor vehicle.

### BACKGROUND

Parking brakes for motor vehicles are known. In DE 197 55 933 C1, a parking brake for motor vehicles with a special releasing device is described. The releasing device serves in the event of a fault, for example if the motorized drive fails when the parking brake is applied, to release the mechanical connection of the axial ends of the telescopic device from each other. The releasing device consists of a relatively expensively made pawl that can be actuated by means of a spring-loaded unlocking lever. In an emergency, this unlocking lever is actuated manually.

### SUMMARY

According to various embodiments, a method for releasing a parking brake of a motor vehicle can be created which can be used in a relatively simple constructional way.

According to an embodiment, a method for releasing a parking brake of a motor vehicle, comprises inserting a drive tool through an opening, closed off by a membrane of the housing of the control drive of the parking brake, into the housing and into a receiving part, wherein said receiving part is connected to a transmission in a rotatable manner, and subsequently, setting the transmission together with the drive tool via said receiving part in a rotary motion to release the parking brake.

According to a further embodiment, an Allen key can be inserted as a drive tool into a hollow body part used as the receiving part with a complementary inner multiple cornered socket embodied for the Allen key. According to a further embodiment, a drive tool with an external thread can be inserted into a hollow body part used as the receiving part with a complementary internal thread embodied for the external thread of the drive tool, with the direction of the thread of the external thread and the internal thread making possible a penetration of the drive tool and a subsequent rotary motion of the transmission only in the direction of opening the parking brake. According to a further embodiment, the drive tool can be inserted through a pressure-equalizing membrane arranged as the membrane into the housing.

### BRIEF DESCRIPTION OF THE DRAWINGS

The invention is described in more detail below with reference to the figures (FIG. 1 to FIG. 4) and by way of examples, in which:

FIG. 1 shows the control drive of the parking brake in the case of an open housing with the drive tool.

FIG. 2 shows the control drive of the parking brake in the case of an open housing with the drive tool in a three-dimensional diagram.

FIG. 3 shows the control drive of the parking brake with an open housing and an inserted drive tool.

FIG. 4 shows an exemplary embodiment of the receiving part in a three-dimensional diagram.

### DETAILED DESCRIPTION

According to various embodiments, in a method for releasing a parking brake of a motor vehicle, a drive tool is inserted through an opening, closed off by a membrane, of the housing of the control drive of the parking brake into the housing and is inserted into a receiving part, said receiving part being connected to the transmission in a rotatable manner, and in which the transmission is subsequently set in a rotary motion with the drive tool via the receiving part to release the parking brake. In this process, a simple screwdriver can for example be used as the drive tool, provided that the receiving part on its side facing the drive tool is for example constructed as a screw head. The membrane is usually a synthetic membrane, which for example is made of polytetrafluorethylene. The receiving part itself can be connected to it at different places of the transmission. In this way, it is for example possible to arrange the receiving part on the side of a gear wheel of the transmission. It has surprisingly been shown that the method for releasing a parking brake of a motor vehicle can be implemented in a relatively simple way. In this process, it is advantageous that releasing the parking brake in an emergency can be brought about in a particularly simple manner by inserting the drive tool. The constructional arrangement of components extending from the transmission to the housing of the control drive can in this process advantageously be dispensed with, which reduces the space required. In a few cases it is also possible, by actuating the drive tool, to make possible a further tightening of the parking brake, if desired. However, the method serves to open the parking brake in an emergency.

An embodiment consists of an Allen key which is used as a drive tool being inserted into a hollow body part used as a receiving part with an inner multiple cornered socket formed in a complementary manner to the Allen key. In this case, the receiving part is made in such a way that it can receive the Allen key. In this way the drive tool in particular can be inserted very easily and securely into the receiving part, which facilitates the execution of the method in an advantageous way. A hexagon socket can for example be chosen as the inner multiple cornered socket here.

In accordance with a further embodiment, a drive tool with an external thread is inserted into a hollow body part used as receiving part with a complementary internal thread embodied for the external thread of the drive tool, with the direction of the external thread and the internal thread making possible the insertion of the drive tool and a subsequent rotary motion of the transmission only in the direction of the opening of the parking brake. The complementary internal thread of the receiving part is embodied for the external thread of the drive tool, so that the drive tool can be screwed into the receiving part. In this process, the directions of the thread are selected in such a way that screwing of the drive tool into the receiving part and a subsequently common further rotary motion of the drive tool together with the receiving part can only take place in the opening direction of the parking brake. In this process, there is the advantage that the user does not have to take long to decide which screwing direction has to be selected for actuating the drive tool in order to release the parking brake of the motor vehicle because only one screwing direction makes possible the screwing of the drive tool into the receiving part and this screwing direction then also corresponds to the screwing direction to be selected for releasing the parking brake.

According to a further embodiment, provision has been made for the fact that the drive tool is inserted by means of a pressure-equalizing membrane into the housing fitted as a membrane. The control drives of parking brakes usually have a pressure-equalizing membrane, by means of which temperature fluctuations in the inside of the control drive in question are equalized. In cases of malfunctioning, if for example the electric motor fails, such a pressure-equalizing membrane can be used as membrane which advantageously does not necessitate the arrangement of additional membranes.

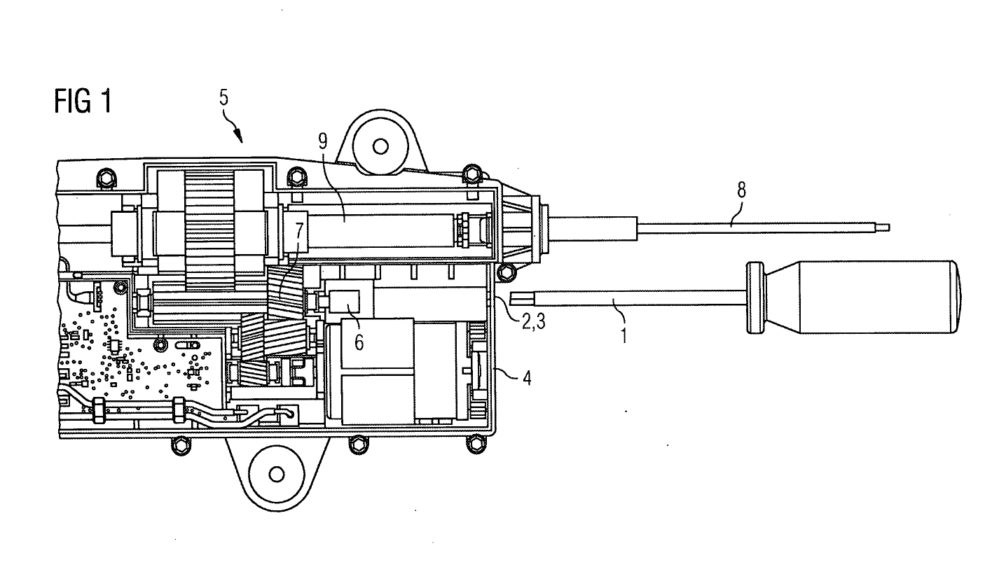

In FIG. 1, the control drive 5 of the parking brake is shown with open housing 4 and the drive tool 1. In the method for releasing the parking brake the drive tool 1 is introduced through an opening 3 closed off by a membrane 2 of the housing 4 of the control drive 5 of the parking brake into a housing 4 and inserted into the receiving part 6. The receiving part 6 is connected rotatably to the transmission 7. In this example, the receiving part 6 is arranged on the side of a gear wheel of the transmission 7. The transmission 7 is connected to a spindle 9 by means of which the cable 8 of the parking brake can be tightened or released by means of a specific axial displacement. A sheathed cable is used in this case as the cable 8. As soon as the drive tool 1 has been inserted into the receiving part 6 (not shown), the transmission 7 is rotated by using the drive tool 1 via the receiving part 6 in order to release the parking brake. In this way, the parking brake of the motor vehicle can be easily released in an emergency, for example when the electric motor of the control drive (not shown) fails. In this case, the drive tool 1 is embodied in an advantageous manner as an Allen key. A hollow body part is arranged as a receiving part 6 with a complementary inner multiple cornered socket embodied for the Allen key. This is particularly advantageous. It is also possible to embody the drive tool 1 as a hollow body part with an inner multiple cornered socket (not shown), with the receiving part 6 being embodied to complement this.

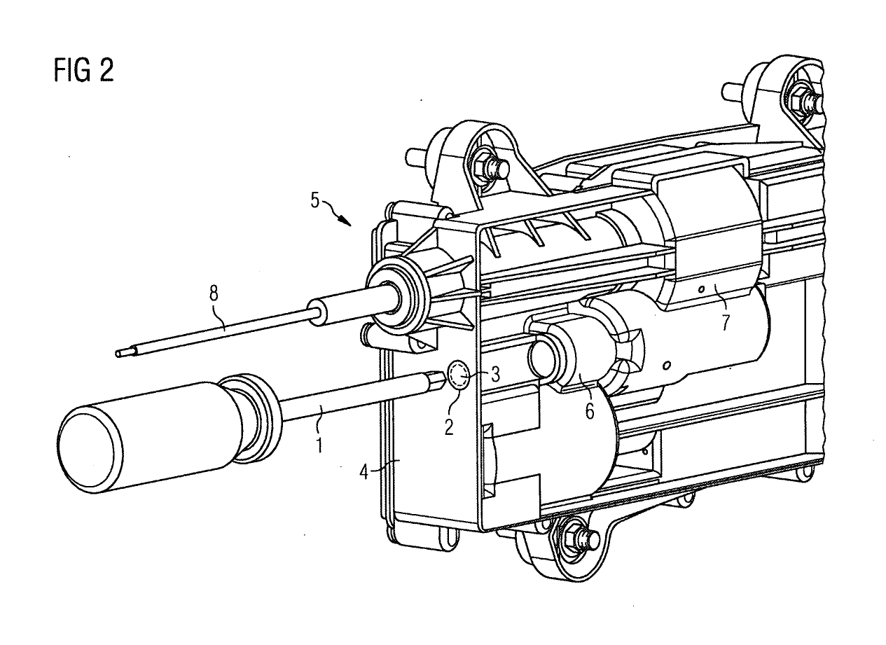

In FIG. 2, the control drive 5 of the parking brake with an open housing 4 and the drive tool 1 are shown in a three-dimensional diagram. The opening 3 of the housing 4 is closed by a membrane 2, which is provided during normal operation as a pressure-equalizing membrane. In order to carry out the method for releasing the parking brake of the motor vehicle, it is not required to provide costly constructional arrangements inside the control drive 5. There is therefore no requirement for example to make provision for an extension from the receiving part 6 to the housing 4 in order to engage the drive tool 1. As a result, the method can be carried out in a particularly cost-effective manner.

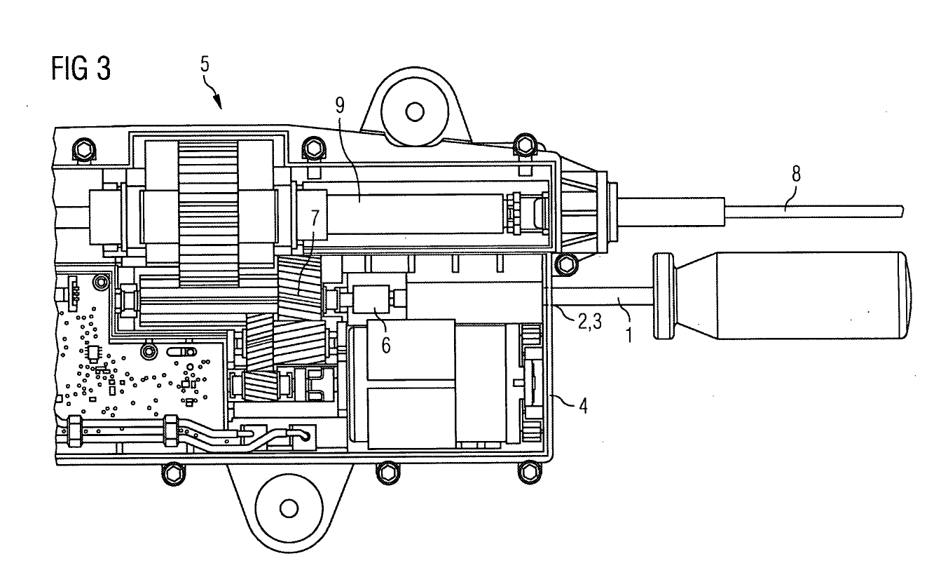

FIG. 3 shows the control drive 5 with an open housing 4 and the drive tool 1, with the drive tool 1 already engaged with the receiving part 6. In order to achieve this, it was necessary to penetrate the membrane 2 with the drive tool 1 and to insert the drive tool 1 into the receiving part 6. The rotary motion can subsequently be undertaken for releasing the parking brake.

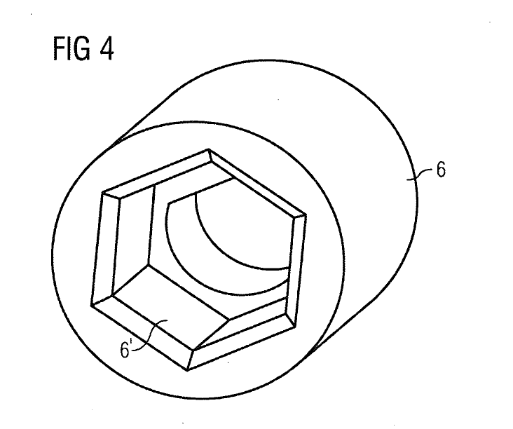

FIG. 4 shows an embodiment of the receiving part 6 in a three-dimensional diagram. In this case, a hollow body part with a complementary inner multiple cornered socket 6′ for the Allen key (not shown) is embodied as the receiving part 6, with a hexagon socket having been selected as the inner multiple cornered socket 6′. This receiving part 6 can for example be pushed onto an extension of a gear wheel which is part of the transmission (not shown).

What is claimed is:

1. A method for releasing a parking brake of a motor vehicle, comprising:
inserting a drive tool through an opening, closed off by a membrane of the housing of the control drive of the parking brake, into the housing and into a receiving part, wherein said receiving part is connected to a transmission in a rotatable manner, and
subsequently, setting the transmission together with the drive tool via said receiving part in a rotary motion to release the parking brake.

2. The method according to claim 1, wherein an Allen key is inserted as a drive tool into a hollow body part used as the receiving part with a complementary inner multiple cornered socket embodied for the Allen key.

3. The method according to claim 1, wherein a drive tool with an external thread is inserted into a hollow body part used as the receiving part with a complementary internal thread embodied for the external thread of the drive tool, with the direction of the thread of the external thread and the internal thread making possible a penetration of the drive tool and a subsequent rotary motion of the transmission only in the direction of opening the parking brake.

4. The method according to claim 1, wherein the drive tool is inserted through a pressure-equalizing membrane arranged as the membrane into the housing.

5. The method according to claim 1, wherein the receiving part is arranged on the side of a gear wheel of the transmission.

6. The method according to claim 1, wherein the transmission is connected to a spindle by means of which a cable of the parking brake can be tightened or released by means of a specific axial displacement.

7. The method according to claim 6, wherein the cable is a sheathed cable.

8. A system for releasing a parking brake of a motor vehicle, comprising:
a control drive having a housing comprising an opening closed by a membrane;
a transmission arranged in said housing;
a drive tool operable to be inserted through the opening into the housing and into a receiving part, wherein said receiving part is connected to the transmission in a rotatable manner, and
wherein the drive tool is further operable to set the transmission together in a rotary motion via said receiving part to release the parking brake.

9. The system according to claim 8, wherein said drive tool is an Allen key and said receiving part is a hollow body part with a complementary inner multiple cornered socket embodied for the Allen key.

10. The system according to claim 8, wherein the drive tool comprises an external thread and the receiving part comprises a hollow body part with a complementary internal thread embodied for the external thread of the drive tool.

11. The system according to claim 10, wherein the direction of the thread of the external thread and the internal thread are allowing a penetration of the drive tool and a subsequent rotary motion of the transmission only in the direction of opening the parking brake.

12. The system according to claim 8, wherein the drive tool is inserted through a pressure-equalizing membrane arranged as the membrane into the housing.

13. The system according to claim 8, wherein the receiving part is arranged on the side of a gear wheel of the transmission.

14. The system according to claim 8, wherein the transmission is connected to a spindle by means of which a cable of the parking brake can be tightened or released by means of a specific axial displacement.

15. The system according to claim 14, wherein the cable is a sheathed cable.
